(19) United States
(12) Patent Application Publication
(10) Pub. No.: US 2008/0111931 A1
(43) Pub. Date: May 15, 2008

(54) Liquid crystal display with frequency conversion module and method for driving liquid crystal display

(75) Inventors: Wei Zhou, Shenzhen (CN); Huai Du, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 11/985,112

(22) Filed: Nov. 13, 2007

(30) Foreign Application Priority Data
Nov. 10, 2006 (TW) 95141778

(51) Int. Cl. G02F 1/133

(52) U.S. Cl. 349/37; 349/33

(57) ABSTRACT

An exemplary liquid crystal display (200) includes a liquid crystal panel (220) and a frequency conversion module (210) electrically coupled to the liquid crystal panel. The frequency conversion module includes a scanning frequency array (230) and a read register (240) that is configured to read the scanning frequency array circularly and form a frequency conversion signal. The frequency conversion signal drives the liquid crystal panel to perform frame inversion. A related method for driving a liquid crystal display is also provided.

### FIELD OF THE INVENTION

The present invention relates to liquid crystal displays (LCDs) and, particularly, to a super twisted nematic liquid crystal display (STN-LCD) with a frequency conversion module and a method for driving the STN-LCD.

### GENERAL BACKGROUND

Generally, STN-LCDs have advantages of low cost and low power consumption, compared with thin film transistor liquid crystal displays (TFT-LCDs). Therefore, STN-LCDs are widely used in devices with small-sized panels, such as mobile phones and portable media players (PMPs).

In operation of a standard LCD, driving voltages are outputted to control the orientations of liquid crystal molecules in pixel regions of a liquid crystal panel of the LCD. Thereby, the liquid crystal molecules tilt and control the transmission of light beams through the liquid crystal panel, and thus an image is displayed on a screen of the liquid crystal panel. However, when the driving voltages are unidirectional, and the unidirectional voltages continue for a long period (i.e., the LCD is displaying a static image), an electrochemical response is liable to be generated in the liquid crystal molecules. The electrochemical response is apt to diminish or destroy the photoelectric characteristics of the liquid crystal molecules. Once the photoelectric characteristics are diminished or destroyed, the liquid crystal molecules may lose their function of being controllable to tilt and thereby display different gray scales according to different driving voltages.

To overcome these problems, a typical LCD is generally driven by a method known as inversion driving. In inversion driving, the driving voltage is divided into a positive polarity voltage and a negative polarity voltage. A tilting direction of the liquid crystal molecules under the driving voltage with a positive polarity is contrary to that under the driving voltage with a negative polarity. Therefore, when the positive polarity voltage and the negative polarity voltage are outputted to the pixel regions of the liquid crystal panel in turn, the liquid crystal molecules can maintain their photoelectric characteristics.

Moreover, the main method of inversion driving for an STN-LCD is frame inversion driving. FIG. 6 is an abbreviated schematic diagram of driving a conventional STN-LCD using a frame inversion method. A frame frequency signal is outputted to the LCD to drive the LCD to perform frame inversion. For simplicity, an image with 4×4 pixels in the LCD is taken here as an example. In the frame inversion 100 of this image, during an Nth frame 101, a polarity of driving voltages of each pixel is the same. Then during an (N+1)th frame 102, the polarity of the driving voltages of all of the pixels is opposite to the polarity of the driving voltages in the Nth frame 101. In addition, the frequency of the frame frequency signal is fixed. For example, the frequency can be 60 Hz (hertz), which means that the period of each frame is 1/60=16.67 ms (milliseconds). Thus the polarity of the driving voltage of the pixels switches to the opposite polarity every 16.67 ms. By adopting the frame inversion method, the LCD can have a simple driving circuit and lower power consumption in overcoming the above-described problem of photoelectric characteristic diminution or destruction that would otherwise exist.

However, in an STN-LCD being driven by the frame inversion method, the fixed value of the frame frequency signal may interfere with ambient light conditions. This occurs when the frequency of the frame frequency signal is equal to the frequency of ambient light, and the phase difference between the frame frequency signal and the frequency of ambient light is constant. In this circumstance, the electromagnetic waves of the frame frequency signal and the light waves are liable to interfere and produce continuous interference signals. The interference signals are liable to be manifested on the display screen of the LCD, whereby typically a so-called flicker phenomenon is generated. As a result, a human viewer perceives that the image is skipping or jumping, and the display quality of the LCD is impaired.

It is, therefore, desired to provide an LCD which can overcome the above-described deficiencies. What is also needed is a related method for driving such an LCD.

### SUMMARY

In one aspect, a liquid crystal display includes a liquid crystal panel and a frequency conversion module electrically coupled to the liquid crystal panel. The frequency conversion module includes a scanning frequency array and a read register that is configured to read the scanning frequency array circularly and form a frequency conversion signal. The frequency conversion signal drives the liquid crystal panel to perform frame inversion.

In a second aspect, a method for driving a liquid crystal display includes: providing a liquid crystal panel; providing a plurality of frequency signals; outputting the frequency signals circularly to form a frequency conversion signal; and the frequency conversion signal driving the liquid crystal panel to perform frame inversion.

In third aspect, a liquid crystal display includes a liquid crystal panel and a frequency conversion module. The frequency conversion module is configured to provide a plurality of frequency signals, and is electrically coupled to the liquid crystal pane. The frequency conversion module further includes a read register. The read register is configured to read the frequency signals circularly, such that a frequency conversion signal is provided to drive the liquid crystal panel to perform frame inversion.

Other novel features and advantages will become more apparent from the following detailed description when taken in conjunction with the accompanying drawings.

### BRIEF DESCRIPTION OF THE DRAWINGS

FIG. 1 is a block diagram of an LCD according to an exemplary embodiment of the present invention.

FIG. 2 is a flow chart of an exemplary method for driving the LCD of FIG. 1, the method comprising step S1, step S2, step S3, and step S4.

FIG. 3 is a flow chart of details of step S2 of the method of FIG. 2.

FIG. 4 is a flow chart of details of step S3 of the method of FIG. 2.

FIG. 5 is a flow chart of details of step S4 of the method of FIG. 2.

FIG. 6 is an abbreviated schematic diagram of driving a conventional STN-LCD using a frame inversion method.

### DETAILED DESCRIPTION OF PREFERRED EMBODIMENTS

Reference will now be made to the drawings to describe preferred and exemplary embodiments of the present invention in detail.

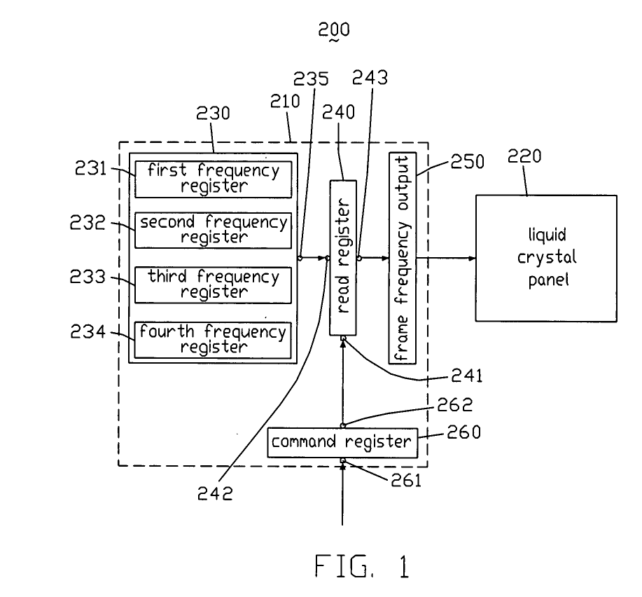

FIG. 1 is a block diagram of a liquid crystal display (LCD) according to an exemplary embodiment of the present invention. The LCD 200 includes a frequency conversion module 210, and a liquid crystal panel 220 electrically coupled to the frequency conversion module 210. The liquid crystal panel 220 can be a super twisted nematic (STN) liquid crystal panel. The frequency conversion module 210 includes a scanning frequency array 230, a read register 240, a frame frequency output 250, and a command register 260. The scanning frequency array 230, the read register 240, and the frame frequency output 250 are electrically coupled in series, and the command register 260 is electrically coupled to the read register 240.

The scanning frequency array 230 includes an output 235, and a plurality of frequency registers for storing frequency signals. In the illustrated embodiment, a first frequency register 231, a second frequency register 232, a third frequency register 233, and a fourth frequency register 234 are taken as an example. The first frequency register 231, the second frequency register 232, the third frequency register 233, and the fourth frequency register 243 are electrically coupled to the output 235, respectively. Each of the frequency registers 231, 232, 233, and 234 stores a fixed frequency signal. Moreover, the frequency signal in each frequency register 231, 232, 233, and 234 is different from the frequency signals in all of the other frequency registers 231, 232, 233, and 234. In the exemplary embodiment, a first frequency signal with a fixed frequency of 60 Hz, a second frequency signal with a fixed frequency of 70 Hz, a third frequency signal with a fixed frequency of 75 Hz, and a fourth frequency signal with a fixed frequency of 85 Hz are stored in the first frequency register 231, the second frequency register 232, the third frequency register 233, and the fourth frequency register 243, respectively. The four frequency signals are all alternating current (AC) square wave signals, and a positive amplitude of each frequency signal is equal to a negative amplitude of the frequency signal.

The read register 240 includes a control terminal 241, an input terminal 242, and an output terminal 243. The control terminal 241 is electrically coupled to the command register 260 to receive a control signal. The input terminal 242 is electrically coupled to the output 235 of the scanning frequency array 230 to read the frequency signals from the scanning frequency array 230 under the control of the control signal. The output terminal 243 is electrically coupled to the liquid crystal panel 220 via the frame frequency output 250 to output the frequency signals, which are read by the read register 240 via the input terminal 242. Moreover, the frame frequency output 250 functions as a buffer, whereby the frame frequency output 250 controls the frequency signals to be outputted to the liquid crystal panel 220 according to a desired timing.

The command register 260 is a programmable device, and includes a command signal input 261 and a control signal output 262. Command signals can be written to the command register 260 via the command signal input 261. The control signal output 262 is electrically coupled to the control terminal 241 of the read register 240. The command register 260 generates a control signal according to the command signals, and outputs the control signal to the read register 240 via the control signal output 262.

Typical operation of the LCD 200 is as follows. The command register 260 receives command signals from a peripheral circuit (not shown) via the command signal input 261, generates a control signal according to the command signals, and then outputs the control signal to the control terminal 241 of the read register 240 via the control signal output 262. Under the control of the control signal, the read register 240 reads the frequency signals from the scanning frequency array 230 circularly.

The control signal can control the reading range in the scanning frequency array 230, as well as the reading interval between two different frequency signals. For example, the control signal can control the read register 240 to read all of the frequency registers 231, 232, 233, and 234 circularly, or to read only the first frequency register 231, the second frequency register 232, and the third frequency register 233 circularly. The reading interval between different frequency signals can be the same as the period of the previous frequency signal under the control of the control signal. Moreover, once a frequency signal is read from the corresponding frequency register 231, 232, 233, and 234, the control signal also controls the read register 240 to output this frequency signal to the frame frequency output 250. As a result, the signal outputted from the output terminal 243 is a frequency conversion signal, which may for example include the first frequency signal, the second frequency signal, and the third frequency signal.

The frame frequency output 250 then outputs the frequency conversion signal to the liquid crystal panel 220. The frequency conversion signal drives pixel regions of the liquid crystal panel 220 to perform frame inversion.

Moreover, in variations of the above-described embodiment, extra frequency registers for storing other frequency signals can be installed in the scanning frequency array 230. Other control signals can be outputted by the command register 260, according to other corresponding command signals received by the command register 260. The other control signals control the read register 240 to read the frequency signals in other desired ranges from the scanning frequency array 230, or control the reading interval between two different frequency signals to be one or more other values. Thereby, different kinds of desired frequency conversion signals can be outputted from the frequency conversion module 210.

In the LCD 200, a frequency conversion signal is generated by the frequency conversion module 210, and this frequency conversion signal is used to drive the liquid crystal panel 220 to perform frame inversion. Thereby, any interference signal caused by interference between an electromagnetic wave of the frequency conversion signal and a light wave of ambient light is discontinuous. Such discontinuous interference signal is not liable to be manifested on a display screen of the liquid crystal panel 220, with a human viewer unable to perceive any image aberration. In particular, any flicker phenomenon of the LCD 200, which may otherwise be manifested, can be diminished or even completely eliminated. Thus, the display quality of the LCD 200 can be improved.

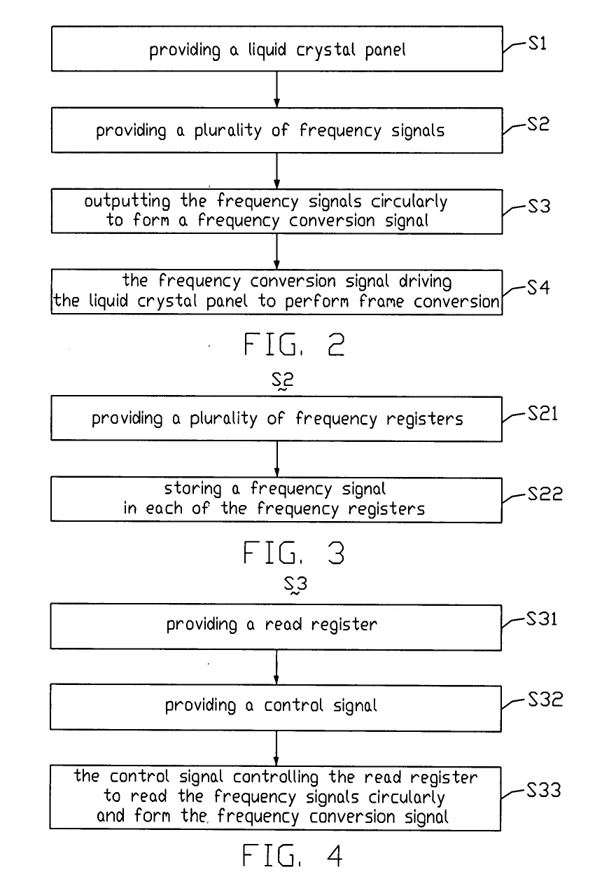

FIG. 2 is a flow chart of an exemplary method for driving the LCD 200. The method includes: step S1, providing a liquid crystal panel; step S2, providing a plurality of frequency signals; step S3, outputting the frequency signals circularly to form a frequency conversion signal; and step S4, the frequency conversion signal driving the liquid crystal panel to perform frame inversion.

In step S1, the liquid crystal panel 220 can be an STN liquid crystal panel.

Referring to FIG. 3, step S2 includes: step S21, providing a plurality of frequency registers; and step S22, storing a frequency signal in each of the frequency registers.

In step S21, the plurality of frequency registers are provided, and the plural frequency registers cooperatively form a scanning frequency array 230. In the exemplary embodiment, a first frequency register 231, a second frequency register 232, a third frequency register 233, and a fourth frequency register 234 are provided.

In step S22, a plurality of frequency signals are stored in the scanning frequency array 230, and each of the frequency signals corresponds to a respective one of the frequency registers 231, 232, 233, 234. A frequency of each frequency signal is different from the frequency of all the other frequency signals. The frequency signals are all AC square wave signals, and a positive amplitude of each frequency signal is equal to a negative amplitude of the frequency signal. In detail, a first frequency signal with a fixed frequency of 60 Hz, a second frequency signal with a fixed frequency of 70 Hz, a third frequency signal with a fixed frequency of 75 Hz, and a fourth frequency signal with a fixed frequency of 85 Hz are stored in the first frequency register 231, the second frequency register 232, the third frequency register 233, and the fourth frequency register 243, respectively.

Referring to FIG. 4, step S3 includes: step S31, providing a read register 240; step S32, providing a control signal; and step S33, the control signal controlling the read register 240 to read the frequency signals circularly and form a frequency conversion signal.

In step S31, a read register 240 is provided, and the read register 240 is electrically coupled to the scanning frequency array 230.

In step S32, a control signal is provided by a command register 260, and the control signal is determined by command signals written to the command register 260.

In step S33, the frequency conversion signal is formed by the read register 240, which reads the frequency signals from the scanning frequency array 230 circularly according to the control signal.

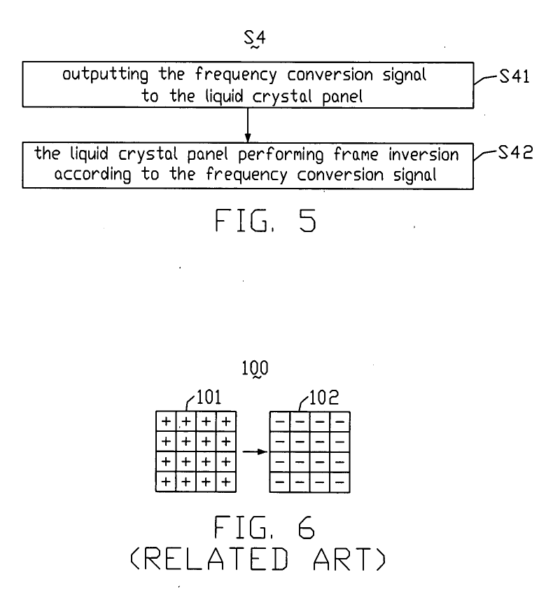

Referring to FIG. 5, step S4 includes: step S41, outputting the frequency conversion signal to the liquid crystal panel 220; and step S42, the liquid crystal panel 220 performing frame inversion according to the frequency conversion signal.

In step S41, the read register 240 outputs the frequency conversion signal to the liquid crystal panel 220 via a frame frequency output 250.

In step S42, the frequency conversion signal controls the liquid crystal panel 220 to perform frame inversion and display images.

In the above-described exemplary method for driving the LCD 200, the liquid crystal panel 220 performs frame inversion according the frequency conversion signal. Thereby, any interference signal caused by interference between an electromagnetic wave of the frequency conversion signal and a light wave of ambient light is discontinuous. Such discontinuous interference signal is not liable to be manifested on the display screen of the liquid crystal panel 220, with a human viewer unable to perceive any image aberration. In particular, any flicker phenomenon of the LCD 200, which may otherwise be manifested, can be diminished or even completely eliminated. Thus, the display quality of the LCD 200 can be improved.

It is to be understood, however, that even though numerous characteristics and advantages of preferred and exemplary embodiments have been set out in the foregoing description, together with details of the structures and functions of the embodiments, the disclosure is illustrative only; and that changes may be made in detail within the principles of the present invention to the full extent indicated by the broad general meaning of the terms in which the appended claims are expressed.

What is claimed is:

1. A liquid crystal display, comprising:
a liquid crystal panel; and
a frequency conversion module electrically coupled to the liquid crystal panel;
wherein the frequency conversion module comprises a scanning frequency array and a read register, and the read register is configured to read the scanning frequency array circularly and form a frequency conversion signal, which drives the liquid crystal panel to perform frame inversion.

2. The liquid crystal display as claimed in claim 1, wherein the scanning frequency array comprises a plurality of frequency registers, each of which is configured to store a respective frequency signal.

3. The liquid crystal display as claimed in claim 2, wherein the frequency signal is an alternating current square wave signal, whose positive amplitude is equal to its negative amplitude.

4. The liquid crystal display as claimed in claim 2, wherein the number of frequency registers is four.

5. The liquid crystal display as claimed in claim 4, wherein the frequency signals stored in the four frequency registers are 60 Hz, 70 Hz, 75 Hz, and 85 Hz.

6. The liquid crystal display as claimed in claim 2, wherein the frequency conversion module further comprises a command register, and the command register is configured to output a control signal to control the read register to read at least one of the frequency signals of the frequency registers in the scanning frequency array.

7. The liquid crystal display as claimed in claim 6, wherein the command register comprises an input terminal to receive command signals, and the command register outputs the control signal according to the command signals.

8. The liquid crystal display as claimed in claim 1, wherein the frequency conversion module further comprises a frame frequency output electrically coupled between the read register and the liquid crystal panel.

9. The liquid crystal display as claimed in claim 1, wherein the liquid crystal panel is a super twisted nematic liquid crystal panel.

10. A method for driving a liquid crystal display, the method comprising:
providing a liquid crystal panel;
providing a plurality of frequency signals;
outputting the frequency signals circularly to form a frequency conversion signal; and
the frequency conversion signal driving the liquid crystal panel to perform frame inversion.

11. The method for driving a liquid crystal display as claimed in claim 10, wherein providing a plurality of frequency signals comprises providing a plurality of frequency registers, and storing a frequency signal in each of the frequency registers.

12. The method for driving a liquid crystal display as claimed in claim 11, wherein the number of frequency registers is four.

13. The method for driving a liquid crystal display as claimed in claim 12, wherein the frequency signals in the four frequency registers are 60 Hz, 70 Hz, 75 Hz, and 85 Hz.

14. The method for driving a liquid crystal display as claimed in claim 10, wherein outputting the frequency signals circularly to form a frequency conversion signal comprises providing a read register, and providing a control signal, the control signal controlling the read register to read the frequency signals circularly and form the frequency conversion signal.

15. The method for driving a liquid crystal display as claimed in claim 14, wherein the control signal is provided by a command register.

16. The method for driving a liquid crystal display as claimed in claim 15, wherein the control signal is determined by command signals written in the command register.

17. The method for driving a liquid crystal display as claimed in claim 10, wherein the frequency conversion signal driving the liquid crystal panel to perform frame inversion comprises outputting the frequency conversion signal to the liquid crystal panel via a frame frequency output, and the liquid crystal panel performing the frame inversion according to the frequency conversion signal.

18. A liquid crystal display, comprising:
a liquid crystal panel; and
a frequency conversion module electrically coupled to the liquid crystal panel, the frequency conversion module configured to provide a plurality of frequency signals;
wherein the frequency conversion module further comprises a read register, and the read register is configured to read the frequency signals circularly, such that a frequency conversion signal is provided to drive the liquid crystal panel to perform frame inversion.

19. The liquid crystal display as claimed in claim 18, wherein each of the frequency signals is an alternating current square wave signal, whose positive amplitude is equal to its negative amplitude.

20. The liquid crystal display as claimed in claim 18, wherein the frequency signals are 60 Hz, 70 Hz, 75 Hz, and 85 Hz, respectively.
